(19) United States
(12) Patent Application Publication
(10) Pub. No.: US 2004/0115504 A1
(43) Pub. Date: Jun. 17, 2004

(54) Fuel cell system with a membrane unit for separating a hydrogen-enriched fuel from a hydrogen-containing mixture

(76) Inventors: Martin Moeller, Stuttgart (DE); Rainer Saliger, Freiberg (DE)

Correspondence Address: STRIKER, STRIKER & STENBY, 103 East Neck Road, Huntington, NY, 11743, US

(21) Appl. No.: 10/699,907

(22) Filed: Nov. 3, 2003

(30) Foreign Application Priority Data
Nov. 6, 2002 (DE) 102 51 567.0

(51) Int. Cl. H01M 8/04; H01M 8/06

(52) U.S. Cl. 429/34; 429/19

(57) ABSTRACT

The fuel cell system has a membrane unit for separating a hydrogen-enriched fuel for a fuel cell unit from a hydrogen-containing mixture, for example a hydrogen-containing mixture produced by a reforming unit. The membrane unit contains a semi-permeable membrane, which is permeable to molecular hydrogen, and at least reduces the amount of certain undesirable gasses, such as CO and CO₂, in the stream passing through it. This semi-permeable membrane is economically constructed in comparison to the state of the art, because it is permeable to molecular hydrogen.

### BACKGROUND OF THE INVENTION

1. Field of the Invention

The present invention relates to a fuel cell system with a membrane unit for separation of a hydrogen-enriched fuel for a fuel cell unit from a hydrogen-containing mixture, wherein the membrane unit comprises a semi-permeable membrane.

2. Description of the Related Art

Fuel cell technology is becoming ever more important, especially in connection with consumer-driven concepts for vehicles. Fuel cells offer the possibility to convert chemical energy directly to electrical energy, which subsequently can be converted into mechanical drive energy with the aid of an electrical motor.

Because of engineering problems involved with hydrogen storage in a vehicle, hydrogen is produced on demand, e.g. by a so-called reformation or reforming of hydrocarbon materials or by partial oxidation of hydrocarbons. These hydrocarbons or hydrocarbon materials are present in the form of commercial fuels, such as gasoline or diesel fuel, however other hydrocarbon materials, for example methane or methanol, can also be used for this purpose.

A so-called PEM fuel cell is frequently used in commercial fuel cell systems, which however reacts to the carbon monoxide content of a hydrogen-rich medium with a “contamination appearance” of the catalytic anode. Thus the conversion of hydrogen at the electrode is made more difficult or prevented when carbon monoxide is present in the hydrogen-rich medium. For this reason suitable fuel cell systems must reliably produce a largely carbon-monoxide-free hydrogen-enriched medium.

Thus the carbon monoxide component in a hydrogen-enriched reformate has already been nearly completely reduced with the help of reactors. For example, in a first step a reactor unit is connected downstream of the reforming unit, which oxidizes the carbon monoxide resulting from the reformation of the fuel to form CO₂ by addition of water by means of a so-called “shift reaction”. In this “shift reaction” additional hydrogen is released. However a residue of carbon monoxide remains in the reformate gas in a concentration, which always still leads to an intolerable contamination of the fuel cell.

Additional reactors are used, as needed, to convert the still remaining carbon monoxide residue, which up to now reduce the carbon monoxide residue nearly completely by catalytic oxidation of the remaining carbon monoxide with added oxygen in a suitable catalytic oxidation unit. In order to reduce the carbon monoxide content to a value less than 50 ppm, preferably a carbon monoxide multi-stage oxidation unit is used, in which oxygen is supplied separately to each stage. The oxygen is generally metered or delivered for this purpose in the form of air oxygen.

Metal membranes have already been used to remove, at least in part, the undesirable gases, such as CO and CO₂, produced in the reforming process. Hydrogen diffuses through these metal membranes, while other undesirable gases substantially cannot pass through the metal membrane. However hydrogen can only diffuse in metal in its atomic form, so that the metal membrane must also be coated with catalytic-active noble metal, such as platinum, silver or the like, for converting molecular hydrogen to atomic hydrogen. This catalytic device is very expensive, which e.g. translates into a high manufacturing cost for suitable membranes. Furthermore during use of the metal membranes, comparatively high operating pressures and operation temperatures are required, which leads to a comparatively high construction cost with a relatively long starting stage.

### SUMMARY OF THE INVENTION

It is an object of the present invention to provide a fuel cell system with a membrane unit, which comprises a semi-permeable membrane, which is satisfactorily realizable economically and has reduced construction expense in comparison to prior art membrane units.

This object and others, which will be made more apparent hereinafter, are attained in fuel cell systems comprising a fuel cell unit and a membrane unit for separating a hydrogen-enriched fuel for the fuel cell unit from a hydrogen-containing mixture.

According to the invention the membrane unit comprises a semi-permeable membrane, which is permeable to molecular hydrogen.

Further advantageous features and embodiments are set forth in the appended dependent claims.

Accordingly the fuel cell systems according to the invention are characterized by the presence of a semi-permeable membrane for separation of a hydrogen-rich fuel stream, which is permeable to molecular hydrogen. This semi-permeable membrane, which is permeable to the hydrogen molecule, i.e. to H₂, can be embodied in an advantageous manner without a catalytic-active material. The economically unsatisfactory noble metals and the making of a suitable catalytic coating or the like are thus dispensed with for this reason. Accordingly both the effort in making the membrane according to the invention and the economic costs for that purpose are decisively reduced.

The production of a required comparatively high operating pressure and/or a correspondingly high operating temperature for operating of the membrane unit can be avoided and they can be at least considerably reduced. This feature thus considerably reduces the construction and operating expenses for the fuel cell system.

In a special embodiment of the invention the membrane can be a plastic membrane. A suitable plastic membrane, i.e. the semi-permeable membrane, is not made of metal, but of a plastic material, which is especially economical to manufacture, so that additional cost reductions are provided.

Furthermore plastic membranes, which are already permeable for molecular hydrogen at comparatively low temperatures, such as temperatures less than 120° C., are especially preferred for use as the semi-permeable membrane in the fuel cell system according to the present invention. In contrast, noble metal membranes are permeable for hydrogen in atomic form at temperatures of about 300° C. Accordingly the expenses for producing and reaching the appropriate operating temperatures are reduced. This leads to, among other things, a plastic membrane, which can reach its operating temperature comparatively rapidly and thus permits the required separation of the detrimental residual gas mixture and enriching of the hydrogen. Thus the dynamics of the entire fuel cell system are considerably improved in an advantageous manner by the present invention.

Preferably the plastic material for the membrane unit is selected and/or adjusted to the operating temperature of the membrane unit and/or to the type and composition of the fuel stream. For example, the selection of the plastic material is performed in an advantageous manner according to the usage of it.

Preferably the semi-permeable membrane is arranged between a fuel cell unit and a reforming unit for reforming a hydrocarbon-containing fuel, especially gasoline, diesel fuel or the like, into the hydrogen-containing mixture for the fuel cell unit. The hydrogen-enriching of the comparatively hydrogen-poor reformate gas produced by means of the so-called reforming process and/or the depletion or reduction of the undesirable gas ingredients, such as CO and CO₂, is accomplished by this arrangement.

It is generally conceivable that a so-called oxidation stage and/or other purification stages further clean or purify a reformate gas mixture or the like to at least partially remove undesirable gas ingredients, such as CO or CO₂. These stages are frequently arranged upstream of the membrane unit and/or upstream of the semi-permeable membrane in relation to the flow direction.

In an advantageous embodiment of the invention the reforming unit includes the membrane unit in its housing or structure. For example, the semi-permeable membrane according to the invention can be integrated into the reforming unit. In this embodiment the semi-permeable plastic membrane can be arranged in an outlet opening of the reforming unit.

Because of the generally customary operating temperatures of plastic membranes they can be advantageously arranged comparatively close to the fuel cell unit. For example, a semi-permeable plastic membrane can be arranged directly in front of the fuel cell unit. In the case of this embodiment the semi-permeable molecular-hydrogen-permeable membrane can be integrated into the fuel cell unit. That means especially that the fuel cell unit includes or contains the membrane unit and/or the semi-permeable plastic membrane according to the invention within its structure.

Preferably the membrane unit has at least one regulating device or regulator for adjustment of a predetermined operating pressure. Generally in comparison with metal membranes, as already mentioned above, lower pressures can be used on the input side of the membrane unit. For example, an operating pressure of less than 10 bar is adjusted by the regulator, e.g. by means of a regulating valve, a controllable pump unit or the like.

In a special embodiment of the invention a feedback device is provided for an at least partial feedback of a hydrogen-containing partial stream from the fuel cell unit to an inlet or entrance to the fuel cell unit. This means that especially a so-called re-circulation loop and/or reutilization of the generally hydrogen-containing anode residual gas is possible. Thereby the total efficiency of the fuel cell system is improved further in an advantageous manner.

Preferably the feedback device includes a membrane unit. In this case at least two semi-permeable hydrogen-molecule-permeable membranes are used according to the invention. One membrane is arranged between the reformer and the fuel cell unit and the other second membrane is arranged in the circulation loop for the feedback.

In another different embodiment of the fuel cell system according to the invention, in which the semi-permeable membrane according to the invention is integrated in the fuel cell unit, a single membrane according to the invention may be used in an advantageous manner. This single membrane is, for example, acted on by both reformate gas and also anode residual gas.

Generally the system efficiency of the fuel cell system, especially with an upstream reformer, is considerably improved with the help of the semi-permeable membrane according to the invention. The entire system structure and/or gas purity and/or hydrogen enrichment are decisively simplified.

Fundamentally the selection of the plastic is performed according to the hydrogen permeation at the appropriate operating temperature and/or the type of undesired gases. Preferably these undesired gases diffuse through the semi-permeable membrane according to the invention only to a comparatively small extent at the operation point of the membrane according to the invention.

### BRIEF DESCRIPTION OF THE DRAWING

The objects, features and advantages of the invention will now be illustrated in more detail with the aid of the following description of the preferred embodiments, with reference to the accompanying figures, in which

FIG. 1 is a diagrammatic cross-sectional view through a first embodiment of a fuel cell system according to the invention with the membrane unit between the reforming unit and the fuel cell unit;

FIG. 2 is a diagrammatic cross-sectional view through a second embodiment of a fuel cell system according to the invention with the membrane unit within the reforming unit;

FIG. 3 is a diagrammatic cross-sectional view through a third embodiment of a fuel cell system according to the invention with the membrane unit within a fuel cell unit; and

FIG. 4 is a diagrammatic cross-sectional view through a fourth embodiment of a fuel cell system according to the invention with the membrane unit between the reforming unit and the fuel cell unit, and with an additional membrane unit in a feedback loop.

### DESCRIPTION OF THE PREFERRED EMBODIMENTS

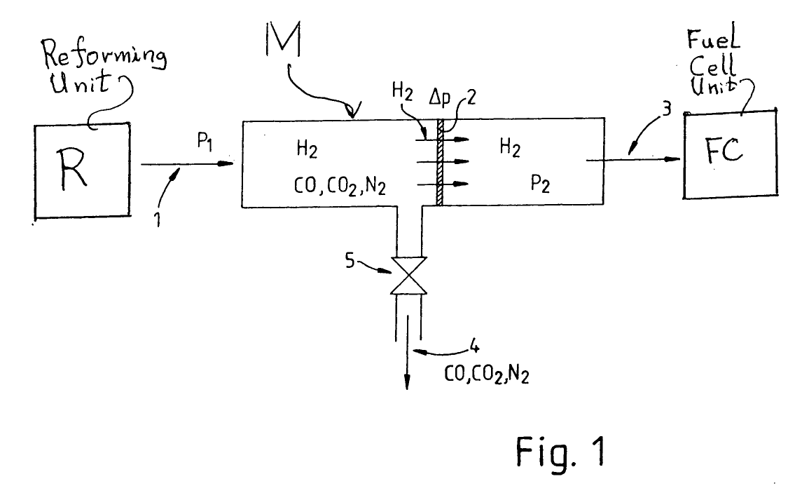

An embodiment of the membrane unit M according to the invention is shown in FIG. 1. The membrane unit M is constructed for enrichment of hydrogen H₂ in a hydrogen-containing fluid stream 1, which flows further to a fuel cell unit FC. For example, the fluid stream 1 is reformate gas 1, which is produced by a reformer R and which especially also contains detrimental gases, such as NOₓ, N₂, CO and CO₂.

The fluid stream 1 is split into a residual stream 4 and into a fuel stream 3, which has considerably greater hydrogen content, H₂, than the fluid stream 1, by means of a plastic membrane 2. The hydrogen H₂ diffuses through the plastic membrane 2 in molecular form.

In FIG. 1 it is clearly shown that the residual stream 4 separated from the fuel stream 3, which flows from the membrane unit M is depleted of hydrogen, i.e. its hydrogen content is reduced. The residual stream 4 has a higher content of unwanted gas ingredients, such as CO, CO₂, N₂ or the like, in comparison to the fluid stream 1.

The operating pressure P₁ in the membrane unit M is adjusted in an advantageous manner by means of a pressure-regulating valve 5 or the like. A pressure drop Δp exists across the membrane 2 so that the pressure p₂ downstream of the membrane 2 is less than the operating pressure p₁ upstream of the membrane. The pressure p₂ is less than the pressure p₁ by an amount equal to Δp.

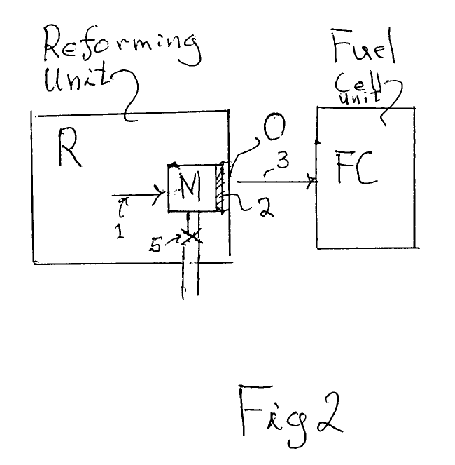

FIG. 2 shows an alternative embodiment, in which the membrane unit M is housed within the reforming unit R. In this embodiment the membrane 2 of the membrane unit M is arranged at the outlet O of the reforming unit R. Parts, which are the same in this embodiment as in the embodiment of FIG. 1, are not discussed in detail and are given the same reference numbers.

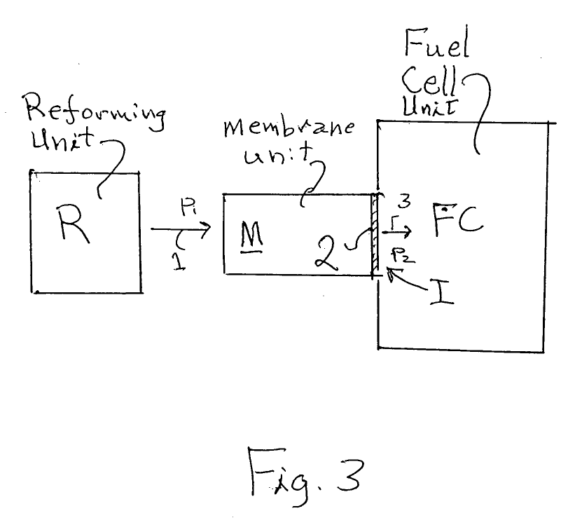

FIG. 3 shows another alternative embodiment, in which the membrane unit M is housed within the fuel cell unit FC. In this embodiment the membrane 2 of the membrane unit M is arranged at the inlet I of the fuel cell itself. Parts, which are the same in this embodiment as in the embodiment of FIG. 1, are not discussed in detail and are given the same reference numbers.

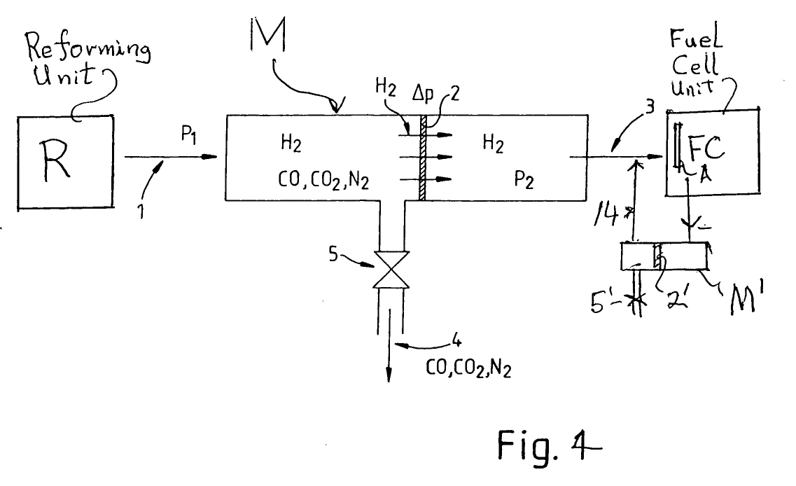

The embodiment of FIG. 4 is basically the same as the embodiment shown in FIG. 1, except that it is provided with another membrane unit M′ with another semi-permeable plastic membrane 2′. This other membrane unit M′ is arranged in a partial stream 14, which originates from the anode A of the fuel cell unit and which is fed back into the stream 3 from the membrane unit M and thus into the inlet of the fuel cell unit FC. This other membrane unit M′ is thus part of a feedback loop, which originates in the fuel cell unit FC and ends at the inlet to the fuel cell unit. This additional membrane unit M′ provides additional removal of residual CO from the hydrogen-enriched fuel reaching the fuel cell unit.

The disclosure in German Patent Application 102 51 567.0 of Nov. 6, 2002 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a fuel cell system with a membrane unit, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A fuel cell system comprising
a fuel cell unit; and
a membrane unit for separating a hydrogen-enriched fuel for the fuel cell unit from a hydrogen-containing mixture;
wherein said membrane unit comprises a semi-permeable membrane, and said semi-permeable membrane is permeable to molecular hydrogen.

2. The fuel cell system as defined in claim 1, wherein said semi-permeable membrane is a plastic membrane.

3. The fuel cell system as defined in claim 2, wherein said membrane unit has an operating temperature and said plastic membrane comprises a plastic material adjusted to said operating temperature

4. The fuel cell system as defined in claim 1, further comprising a reforming unit for converting a hydrocarbon fuel to said hydrogen-containing mixture and wherein said semi-permeable membrane is arranged between said reforming unit and said fuel cell unit.

5. The fuel cell system as defined in claim 4, wherein said hydrocarbon fuel is gasoline, diesel fuel, methane or methanol.

6. The fuel cell system as defined in claim 1, further comprising a reforming unit for converting a hydrocarbon fuel to said hydrogen-containing mixture and wherein said membrane unit is included within the reforming unit.

7. The fuel cell system as defined in claim 6, wherein said hydrocarbon fuel is gasoline, diesel fuel, methane or methanol.

8. The fuel cell system as defined in claim 1, further comprising a reforming unit for converting a hydrocarbon fuel to said hydrogen-containing mixture and wherein said membrane unit is at least included within said fuel cell unit.

9. The fuel cell system as defined in claim 8, wherein said hydrocarbon fuel is gasoline, diesel fuel, methane or methanol.

10. The fuel cell system as defined in claim 1, wherein said membrane unit comprises at least one control device for adjustment of a predetermined operation pressure in said membrane unit.

11. The fuel cell system as defined in claim 1, further comprising a feedback device for at least partial feed back of a hydrogen-containing partial stream from the fuel cell unit to an inlet to the fuel cell unit.

12. The fuel cell system as defined in claim 11, wherein the feedback device contains an additional membrane unit for hydrogen-enrichment of said hydrogen-containing partial stream and said additional membrane unit contains a molecular-hydrogen-permeable plastic membrane.
